(19) United States
(12) Patent Application Publication
(10) Pub. No.: US 2003/0050816 A1
(43) Pub. Date: Mar. 13, 2003

(54) Systems and methods for network-based employment decisioning

(76) Inventors: George R. Givens, Mechanicsville, VA (US); Alison D. Keller, Richmond, VA (US); Mark H. Ludwick, Richmond, VA (US)

Correspondence Address: Finnegan, Henderson, Farabow,, Garrett & Dunner, L.L.P., 1300 I Street, N.W., Washington, DC, 20005-3315, US

(21) Appl. No.: 10/214,771

(22) Filed: Aug. 9, 2002

Related U.S. Application Data
(60) Provisional application No. 60/310,841, filed on Aug. 9, 2001.

(51) Int. Cl. G06F 17/60

(52) U.S. Cl. 705/7

(57) ABSTRACT

Systems and methods are provided for determining whether to hire a candidate for a job position. The disclosed systems and methods provide a preliminary screening process to determine whether to process a candidate on-site. If it is determined to process the candidate further, an appointment is scheduled with the candidate for on-site processing. During the on-site processing, the candidate may view on-line descriptions of the available jobs, apply for one or more jobs of interest, and complete selection tools, such as candidate instruments and assessor instruments, relating to a job of interest. The candidate's performance on the selection tools may be processed to determine whether to extend the candidate an offer for a particular job. If the candidate does not qualify for his first choice job, the candidate may be tested for another job of interest. The candidate instruments may include electronic tests, simulations, and/or interviews, for example. The assessor instruments may include live job simulations and/or an in-person interview, for example.

### CROSS REFERENCE TO RELATED APPLICATION

This application is related to and claims the benefit of priority under 35 U.S.C. 119(e) to U.S. Provisional Patent Application No. 60/310,841, filed on Aug. 9, 2001, the disclosure of which is expressly incorporated herein by reference in its entirety.

### BACKGROUND OF THE INVENTION

I. Field of the Invention

The present invention generally relates to employment decisioning and, more particularly, to systems and methods for determining whether to employ a job candidate.

II. Background of the Invention

Most employees are hired based largely upon their performance during one or more behavioral interviews with a company. During a behavioral interview, an interviewer asks a job candidate a series of questions and then decides whether to hire the candidate based on the candidate's response to those questions. Some employees are hired using multiple-choice tests.

This conventional approach has numerous shortcomings. At least one person at the company must interview each candidate in a one-on-one fashion. Companies that are rapidly expanding, for example, may not have the capacity (i.e., the funds or personnel) to interview a large amount of candidates in this way. Further, companies that have a volatile size may have trouble adapting to the various number of candidates that are being interviewed at a particular time.

Further still, conventional interviews may not give the employer an accurate prediction of the candidate's job performance, nor the candidate an accurate view of the job. In addition, the lack of structured guidelines for determining whether to hire a candidate may cause the company to give varying responses to similarly situated candidates. A lack of structure to the employment decisioning process may also lead to undue delay in the candidate with a response, such as an offer or a rejection.

It is therefore desirable to find a flexible hiring approach that may be used for interviewing several candidates without greatly changing the demands on a company's recruiting staff. It is also desirable to reduce the cost per hired candidate, the time to make a hiring decisioning, and the subjectivity of the interviewing process, while providing the candidate with a more realistic view of the job and increasing the quality of the type of candidate hired.

### SUMMARY OF THE INVENTION

In accordance with an embodiment of the invention, a system is provided for processing a job candidate who is applying for a job position. The system may include: a receiving unit that receives a request from a job candidate about whether a job position is available; a decisioning unit that determines whether to approve the job candidate for the requested job position based on applicant information provided by the job candidate; a scheduler that schedules the candidate for further application processing when the job candidate is approved for the requested job position; and a database that stores the applicant information from the job candidate, the approval determination, and any scheduling information for any scheduled appointment for further application processing.

Consistent with another embodiment, a network based computer system is provided for determining whether to hire a candidate. The system may comprise: a receiving unit that receives a request from a candidate to apply for a first job position; an interface component that presents to the candidate a predetermined skills test that is selected based on the first job position requested by the candidate; a scoring component for determining a candidate score based on responses made by the candidate to the predetermined skills test; and a decisioning component for determining whether to accept the candidate for hiring based on the determined candidate score.

In accordance with another embodiment of the invention, a method is provided for processing a job candidate applying for a job position. The method may include the following steps: receiving a request from a job candidate about whether a job position is available; determining whether to approve the job candidate for the requested job position based on applicant information provided by the job candidate; scheduling the candidate for further application processing when the job candidate is approved for the requested job position; and storing the applicant information from the job candidate, the approval determination, and any scheduling information for any scheduled appointment for further application processing.

Consistent with still another embodiment of the invention, a method is provided for determining whether to hire a candidate. The method may include the steps of: receiving a request from a candidate to apply for the first job position; testing the candidate using a predetermined skills test that is selected based on the first job position requested by the candidate; scoring a candidate with a candidate score based on responses made by the candidate to the predetermined skills test; and deciding whether to accept the candidate for hiring based on the candidate score.

Additional features and aspects of embodiments of the invention will be set forth in part in the description which follows, and in part will be obvious from the description, or may be learned by practicing embodiments of the invention. It is to be understood that both the foregoing general description and the following detailed description are exemplary and explanatory only and are not restrictive of the scope of the invention, as claimed.

### BRIEF DESCRIPTION OF THE DRAWINGS

The accompanying drawings are incorporated in and constitute a part of this specification. In the drawings:

FIG. 1 is an exemplary block diagram of an employment decisioning system 10, consistent with an embodiment of the present invention;

FIG. 2 is an exemplary block diagram of support staff configuring the employment decisioning system 10, consistent with an embodiment of the present invention;

FIG. 3 is an exemplary flow diagram of a method, consistent with an embodiment of the present invention, for determining whether to hire a candidate using employment decisioning system 10;

FIG. 4 is an exemplary flow diagram of a method, consistent with an embodiment of the present invention, for performing front-end processing of a candidate;

FIG. 5 is an exemplary flow diagram of a method, consistent with an embodiment of the present invention, for performing on-site processing of a candidate;

FIG. 6 is an exemplary flow diagram of a method, consistent with an embodiment of the present invention, for implementing candidate instruments 102, described above with reference to the features of step 310 of FIG. 3; and

FIG. 7 is an exemplary flow diagram of a method, consistent with an embodiment of the present invention, for implementing step 616 of FIG. 6.

### DESCRIPTION OF THE EMBODIMENTS

Reference will now be made in detail to embodiments of the invention, examples of which are illustrated in the accompanying drawings. Wherever possible, the same reference numbers will be used throughout the drawings to refer to the same or like parts.

Systems and methods consistent with embodiments of the present invention provide a framework for network-based employment decisioning. Various network-based environments may be used to implement embodiments of the invention. Such environments and related applications may be specially constructed for performing the various processes and operations of embodiments of the invention or they may include a general purpose computer or computing platform selectively activated or reconfigured by program code to provide the necessary functionality. The exemplary methods disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on embodiments of the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

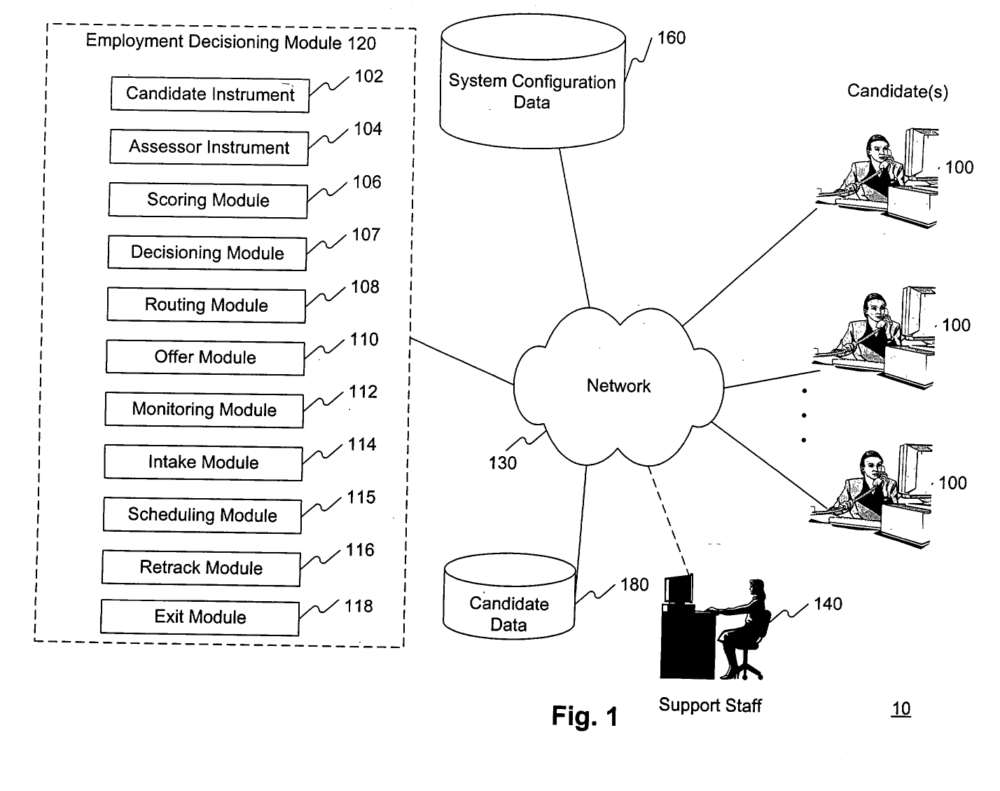

In accordance with an embodiment of the invention, systems and methods may be implemented to determine whether to hire a candidate for a job using an employment decisioning system, such as employment decisioning system 10 (see FIG. 1). Generally, employment decisioning system 10 may subject the candidate to a candidate instrument 102 and/or an assessor instrument 104 associated with a job to which the candidate is applying and determine, based on the candidate's performance with candidate instrument 102 or assessor instrument 204, whether to hire the candidate for a job. If system 10 determines not to hire the candidate for the job to which the candidate is applying, system 10 may retrack the candidate for a second job using candidate instrument 102 and/or assessor instrument 104 associated with a second job to assess the candidate. Candidate instrument 102 may included at least one of a computerized test, simulation and/or interview. Similarly, assessor instrument 104 may include a test, simulation, and/or interview that involves another participant, such as a recruiter. The candidate instrument 102 or assessor instrument 104 may be provided to the candidate over a network, such as network 130.

FIG. 1 is an exemplary block diagram of employment decisioning system 10, consistent with an embodiment of the present invention. Employment decisioning system 10 may be implemented as a centralized employment decisioning system that allows a company to evaluate a plurality of candidates 100 simultaneously. System 10 may be provided by an employer or by a company on behalf of a group of employers. In this way, a candidate may be evaluated for one or more jobs at a single employer or for one or more jobs at various employers.

As illustrated in FIG. 1, employment decisioning system 10 may comprise one or more candidates 100, a support staff 140, a network 130, a system configuration database 160, a candidate database 180, and an employment decisioning module 120. Employment decisioning module 120 may include one or more components or modules, such as a candidate request module 101, a candidate instrument 102, an assessor instrument 104, a scoring module 106, a decisioning module 107, a routing module 108, an offer module 110, a monitoring module 112, an intake module 114, a scheduling module 115, a retrack module 116, and/or an exit module 118.

Employment decisioning module 120 may perform a combination of front-end processing and on-site processing of job candidates. Front-end processing may include providing information to a job candidate regarding available jobs, receiving information from the candidate, and processing the information to determine whether the candidate meets predetermined criteria for further on-site candidate processing. If the candidate meets the predetermined criteria, decisioning module 120 may allow the candidate to schedule an appointment for further processing for the selected job by employment decisioning system 10.

The front-end processing may begin with candidate request module 101. Candidate request module 101 may present information regarding open job positions to candidate 100 over a network 130. Module 101 may also provide general information regarding a company, available jobs at the company, and benefit information. In one embodiment, network 130 may be any type of network, such as public or private network, an intranet, a local area network, a wide area network, or a global network such as the Internet. In another embodiment, network 130 may further include a public switch telephone network connected to a telephone automated voice recognition unit (VRU).

Candidate 100 may select from a list of available jobs one or more jobs of interest. Employment decisioning module 120 may present one or more candidate instruments to candidate 100 corresponding to a particular job. Candidate instrument 102 may comprise any internally developed or commercially acquired selection test instruments that provide raw scores. The raw scores indicate the candidate's performance on the instrument and may be used by employment decisioning system 10 to assess a candidate's value as a potential employee. Some exemplary instruments to implement candidate instrument 102 include prescreen tests, realistic job previews, bio data tests, applications with candidate approvals, cognitive and non-cognitive tests, computer simulations, and credit checks. Some exemplary vendor provided candidate instruments include customer contact select (CSS), Practical Office Arithmetic (POS), and/or Journal of Artificial Societies and Social Stimulation (JASS). In one embodiment, candidate instrument 102 is accessed and completed by candidate 100 at a Web site. However, in an alternate embodiment, candidate 100 may complete a candidate instrument using automated voice response technology.

During the front-end processing, candidate instrument 102 may query candidate 100 regarding his job preferences and work history to determine whether the candidate's interests and work habits match any available jobs. Scoring module 106 may standardize a raw score received from completed candidate instrument 102 and submit the standardized score to decisioning module 107. Decisioning module 107 may accept the standardized score, determine whether the candidate 100 qualifies for further processing, and pass the decision to intake module 114. In one embodiment, decisioning module 107 may determine that a candidate qualifies for further processing when the standardized score meets or exceeds a cutoff score for a particular job.

If candidate 100 qualifies for further application processing, intake module 114 may transfer candidate 100 to scheduling module 115 to schedule an appointment for further on-site processing. Alternatively, or in addition, intake module 114 may provide candidate 100 with a telephone number to call an operator or service representative during designated hours to schedule an appointment. Scheduling module 115 may store the candidate's scheduled appointment in candidate database 180. If candidate 100 does not qualify for further application processing, then intake interface 114 may gracefully exit candidate 100 from the application process using exit module 118. For example, exit module 118 may thank the candidate for his time and advise him that his application will be kept on file for the next six months.

If the candidate qualifies for further processing, he may be evaluated on-site using one or more candidate instruments 102 and/or assessor instruments 104. Candidate instrument 102 may comprise a selection test, described in detail above, that candidate 100 may complete through self-serve Web pages. Assessor instrument 104 may comprise a selection test that support staff 140 completes through self-serve Web pages during an interactive session with candidate 100. Assessor instrument 104 may comprise any internally developed or commercially acquired selection test instrument that provide scores used by employment decisioning system 10 to assess a candidate's value as a potential employee. Exemplary assessor instruments 104 include, for example, interviews, job fit, business simulations, cases, phone simulations, and/or other interactive simulations. Output of both candidate instrument 102 and assessor instrument 104 may include a raw score for real-time submission to scoring module 106. The scores may be stored in candidate database 180.

Scoring module 106 may accept raw scores from candidate instrument 102 and assessor instrument 104, standardize each of the scores, and/or process composite scores. The composite score may be created from the standardized scores using a weighted average or Boolean logic. One skilled in the art can recognize that numerous analytical or numerical methods may be used for creating a composite score.

Decisioning module 107 may accept a standardized score and/or a composite score from scoring module 106 and generate a pass/fail status based on that score. Decisioning module 107 may compare the score with a predetermined threshold, i.e., a cutoff score, for an instrument to determine whether a candidate passes or fails the instrument. In one embodiment, a candidate passes the instrument when his score meets or exceeds the cutoff score and fails the instrument when his score is lower than the cutoff score. When the candidate passes every instrument for a particular job, decisioning module 107 generates a pass status. Otherwise, decisioning module 107 generates a fail status.

Routing module 108 receives a pass or fail status from decisioning module 107. Routing module 108 may navigate a candidate through the on-site portion of decisioning system 10 based on the pass or fail status generated by decisioning module 107 or a candidate's selection to withdrawal from the on-site processing. For example, if routing module 108 receives a pass decision from module 107, it may determine a next candidate instrument 102 or assessor instrument 104 for the candidate to complete. However, if routing module 108 receives a fail decision from module 107 or a withdrawal selection from the candidate, it may send the candidate to exit module 118 to receive an exit script.

In an alternative embodiment, because the logic of routing module 108 may be unique for a particular job or jobs for which the candidate is being evaluated, module 108 may retrack a candidate to a candidate instrument 102 or assessor instrument 104 associated with a different job after receiving a fail decision from decisioning module 107. In this way, a candidate may be processed by system 10 for a second job if he is not qualified for the first. However, if a candidate fails one candidate instrument 102 or assessor instrument 104 associated with each job, the candidate may be exited from system 10. Routing module 108 may continue to direct the candidate selection process until the candidate is directed to offer module 110 or exit module 118.

In the exemplary embodiment, if a candidate fails a candidate instrument 102 or assessor instrument 104 and exits the program, it may be assumed that the candidate does not qualify for further retracking (i.e., the candidate has already been retracked through all of the job options.) Generally, this retracking may be performed for jobs that a candidate previously indicated as an acceptable, back-up position, for example. However, one skilled in the art can recognize that routing module 108 may retrack a candidate's testing for an alternative job without previous indication by the candidate for interest in that job.

The current routing position of the candidate in the process may be stored in candidate database 180. Routing module 108 also may retrieve the routing position stored in candidate database 180 to allow a candidate to begin where he last left off (i.e., at the beginning of the last incomplete subsystem), if there is a situation, such as a power outage, family emergency or other reason, during the candidate's selection process that prevents the candidate from completing the processing by system 10 that day. For example, the candidate may reschedule to complete the processing using system 20 and during the scheduled appointment, routing module 108 may read candidate database 180 to find a routing position associated with the candidate (i.e., the last substation the candidate did not complete), and route the candidate according to the routing position.

Offer module 110 provides scores from decisioning module 107 to assist the recruiter in making an offer to a candidate who has passed every candidate instrument 102 and assessor instrument 104 required for a job position. Offer module 110 may record whether a candidate accepts or declines an offer or requires additional information or time prior to deciding on the offer. Offer module 110 may complete the employment decisioning process for the qualified candidate by, for example, extending an offer to the candidate.

Retrack module, 116 accepts candidate status from routing module 108 for a candidate who fails a candidate instrument 102 or assessor instrument 104, but may qualify for another job of a lower skill level. Retrack module 116 may provide an automatic real-time change in the candidate job application directing the candidate to a job where the candidate might be a successful applicant. Module 116 may identify instruments requiring completion for a new job position and forward to routing module 108 a retrack from the former job position to the new job position.

Monitoring module 112 may monitor each candidate by providing a complete, real-time view to support staff 140 of the progression of each candidate during on-site processing. In an exemplary embodiment of the invention, monitoring module 112 may indicate a particular candidate instrument 102 or assessor instrument 104 that a candidate is working on, as well as the length of time the candidate has been at the particular candidate instrument 102 or assessor instrument 104.

Monitoring module 112 may also provide information from decisioning module 107 indicating whether the candidate has passed or failed the current subsystem. If a candidate passes a candidate instrument 102 or assessor instrument 104, then monitoring module 112 may indicate the next candidate instrument 102 or assessor instrument 104 the candidate should be moved to as determined by routing module 108. Support staff 140 may use the information provided by monitoring module 112 to instruct the candidate regarding the next candidate instrument 102 or assessor instrument 104 that he will complete, or to lead a customer to a new location, for example.

If a candidate fails a particular candidate instrument 102 or assessor instrument 104, monitoring module 112 may show an exit script to deliver to the candidate. For example, the exit script may thank the candidate for completing the application process and advise the candidate that his information will be evaluated and he will receive a response in, for example, 7-10 days. The exit script may also prompt support staff 140 to request the candidate to complete a survey.

By using the information provided by monitoring module 112, support staff 140 may guide the candidate throughout the on-site processing and help candidate 100 stay within allotted time constraints. One skilled in the art can recognize that monitoring module 112 may be specific to a specific site of a company, inclusive to all sites, or a combination thereof. For example, in one embodiment, monitoring module 112 may be site specific for support staff 140 at a specific site, and may show the sites in aggregate to a centralized recruiting unit.

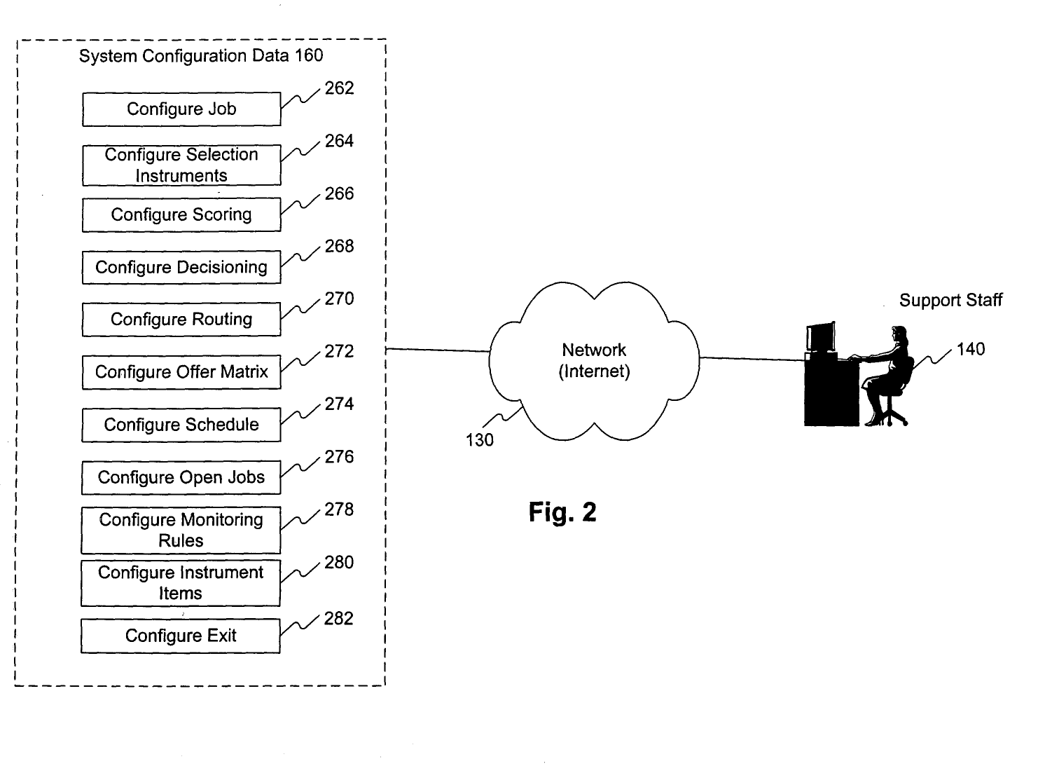

FIG. 2 is an exemplary block diagram of support staff for configuring the employment decisioning system 10, consistent with an embodiment of the present invention. As illustrated in FIG. 2, support staff 140 may enter system configuration data 160 over network 130, such as the Internet. System configuration data 160 may contain the software logic for each of the modules and instruments in employment decisioning system 10. By way of example, system configuration data 160 may include configure job 262, configure selection instruments 264, configure scoring 266, configure decisioning 268, configure routing 270, configure offer matrix 272, configure schedule 274, configure open jobs 276, configure monitoring rules 278, configure instrument items 280, and/or configure exit 282 software logic.

Configure job 262 receives input regarding an employer's job codes, job titles, and job grouping structure or job families, as well as selection-specific differences among positions within the same job. For example, a customer contact representative (CCR) may be a job classification used by the employer's system and processes. The employer may need some CCRs to be fluent in Spanish and English and some CCRs to be fluent in only English. The candidates applying for a bi-lingual CCR position may receive an additional test in language fluency or skills. Therefore, configure job 262 enables system 10 to distinguish positions within a job that receive additional tests.

Configure job 262 may be configured by support staff 140 mapping recruiting job codes onto the organization job codes. In this manner, configure job 262 allows support staff 140 to map the job internal system to the employer's job classification system. Configure job 262 also may be configured to determine the recruitment job titles and descriptions that candidates view during a realistic job preview instrument to learn about and select open jobs.

Configure selection instruments 264 configures the order and types of candidate instruments 102 and/or assessor instruments 104 used during a selection process for a job. The configuration may be distinct for a particular recruit job as well as a particular candidate. For example, a candidate who is a current employee may receive a different selection process than an external applicant.

Configure selection instruments 264 also provides linkages between instruments provided by an external vendor and system 10. For example, configure selection instruments may uniquely identify each instrument by a unique identifier and label, uniquely identify each score produced by each instrument that will be captured by the invention, convert the scores produced by the instrument into scores that may be used by the invention's scoring process, automatically launch the instrument for a candidate as needed to an appropriate workstation, transfer relevant candidate identification information to the instrument as required to launch or re-launch the instrument to a candidate after a system disruption, uniquely identify the location where the invention will find the responses the candidate provides to the instrument, uniquely identify the location where the invention will find candidate's scores from the instrument if the instrument has an internal algorithm for summarizing the candidate's answers into total scores, and/or identify when the candidate has completed or exited the instrument.

Configure scoring 266 provides the software logic for scoring module 106 to standardize raw scores produced by candidate instrument 102 and assessor instrument 104. The raw scores may be standardized by converting the scores to a common score distribution used for all scores. The scores may be combined across instruments as a cross-instrument composite score, which may be provided to the decisioning module 107. Further, boolean logic may be applied to scores. For example, the scoring module 106 may be configured to pass candidates who score below a threshold score on an instrument if they have at least five years of experience, and fail them if they score below a threshold score on the instrument and have less than five years of experience.

In addition, configure scoring 266 may combine composites to form a higher-order composite. For example, a composite that measures problem-solving skills and a composite that measures decision-making skills may be computed across various selection instruments. The problem-solving composite and decision-making composite may be combined to form a higher order composite for forwarding to decisioning module 107.

Configure decisioning 268 may provide the software logic for decisioning module 107 to decision candidates for a particular job. Configure decisioning 268 may create and modify cutsets for each job. A cutset is an entire set of cutoffs that a candidate's score from scoring module 106 must meet or exceed to qualify for a particular job.

Configure routing 270 may provide the software logic for routing module 108 to navigate the candidate in employment decisioning system 10. Configure routing 270 may include configuring for each job position the candidate and assessor instruments included in the selection process, the order instruments may be presented to candidates, the exit points in the process to exit or retrack candidates who are failing, the number of times a candidate may retrack to another job's selection system, and a launch algorithm for launching offer module 110 for successful candidates.

Configure offer matrix 272 may configure instrument scores, job preferences, qualifications, salary history and request(s), and availability to start employment for each job selection process. The configured information may assist support staff 140, such as a recruiter, in determining job interest, qualification, salary and availability required to make the candidate an offer.

Configure schedule 274 may configure a schedule for on-site processing. For each site at which the candidate is processed, configure schedule 274 may configure the number of candidate workstations, hours of operation, number of interview locations, and number of concurrent time slots available for candidate processing. For each job, configure schedule 274 may configure the duration of an on-site session and the number of candidates to meet candidate-to-hiring ratios. For example, if five candidates are typically processed for every one candidate who is hired (i.e., a candidate-to-hiring ratio of 5:1) and 5 candidates must be hired, 25 candidates should be scheduled for on-site processing.

Configure open jobs 276 may configure for each job at each site, a number of open positions for each job and a priority of the job at the site for time slots. Configure open jobs 276 may also track the number of successful candidates for each job.

Configure monitoring rules 278 may configure for each job at each site candidate status rules for recruiter action, candidate instruments and assessor instruments to include in the dash board or display, candidate status and notification rules for exit, interview locations, offer matrix, candidate instruments expected time and time in instrument, and assessor instrument expected time and time in instrument or waiting to begin an assessor instrument.

Configure instrument items 280 configures items index and values of the response for each version of the instrument.

Configure exit 282 defines a code for each job and exit point for a predefine letter to inform the candidate on the outcome of the selection process.

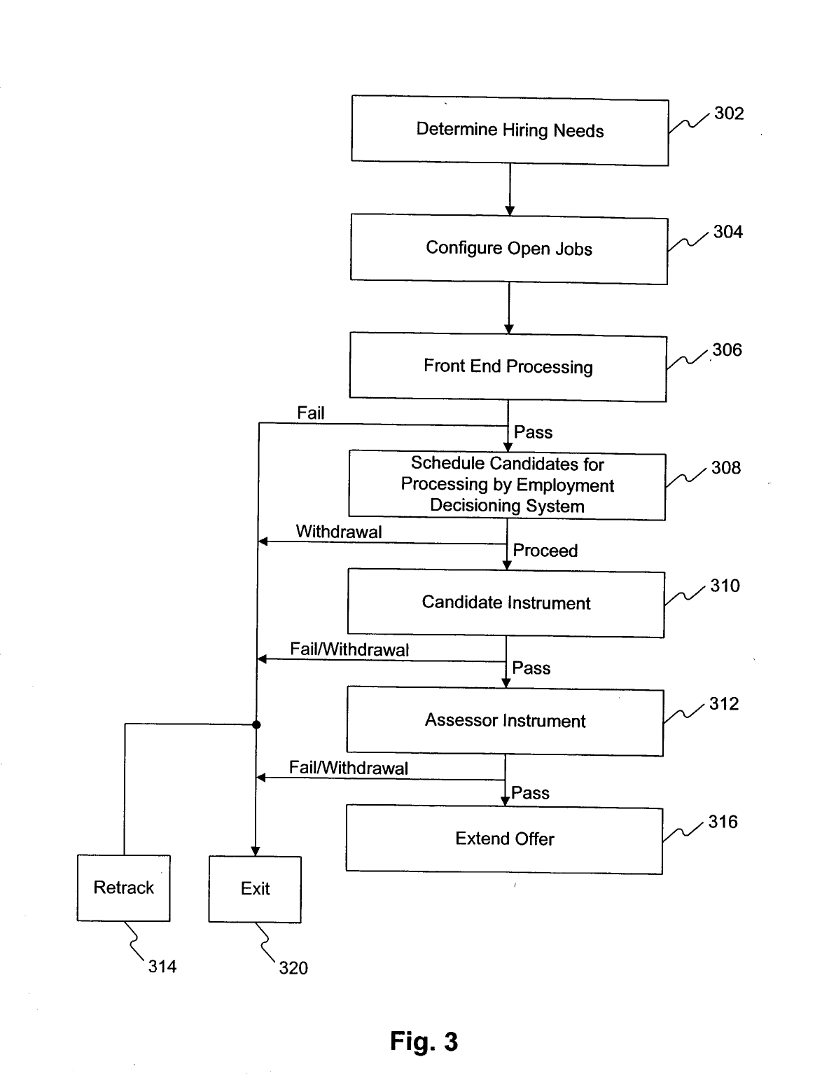

FIG. 3 is an exemplary flow diagram of a method, consistent with an embodiment of the present invention, for determining whether to hire a candidate using employment decisioning system 10. As shown in FIG. 3, before hiring a candidate, a company may first determine its hiring needs (step 302). For example, a company may forecast its hiring needs over the next several months and generate specific hiring schedules based on the forecasted information. Recruiting may begin several weeks before the created start date for the new positions, depending on the nature of the position. For example, a more specialized position, such as a manager, likely will take a longer period of time to fill than a less specialized position, such as a call center position.

After determining hiring needs, a company may configure open jobs on employment decisioning system 10, thereby posting open job positions and interview schedules (step 304). By posting the jobs on a Web site or on a VRU, for example, the company allows candidates to have current information regarding any available positions. The company may also consider advertising vacant positions by radio, television, newspaper, job fair, or other medium to increase the flow of candidates to the VRU or Web site or similar system 10, consistent with an embodiment of the present invention.

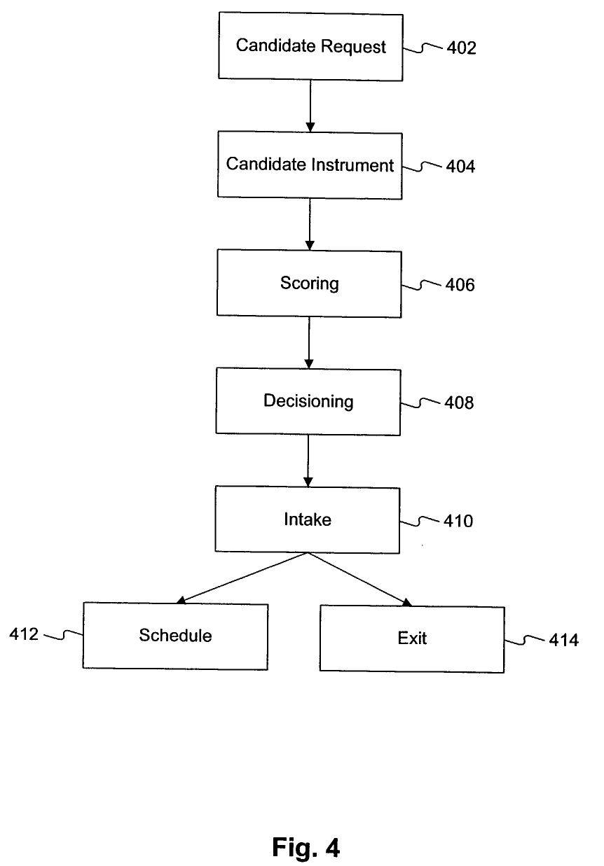

After posting job positions and interview schedules, employment decisioning module 120 may perform front-end processing of each candidate (step 306). Front-end processing may include providing information to a job candidate regarding available jobs, receiving information from the candidate, and processing the information to determine whether the candidate meets predetermined criteria for further on-site candidate processing. If the candidate meets the predetermined criteria, he receives a pass score. Otherwise, he receives a fail score. The candidate's score and other data may be stored in candidate database 180. The operation of step 306 is described in greater detail with reference to the embodiment of FIG. 4.

Candidates with a pass score may schedule an appointment for on-site processing by employment decisioning system 10 (step 308). In an embodiment of the invention, the candidate may schedule the appointment over a telephone network via a VRU or on-line via a Web site. In an alternative embodiment of the invention, the candidate may call support staff 140 to schedule the appointment. By way of a non-limiting example, the scheduling process is described in greater detail below with reference to the embodiment FIG. 4. Scheduling data may be saved in candidate database 180.

If the candidate does not wish to schedule an interview for employment decisioning processing using system 10, the candidate may withdraw from the application process at this time (step 320). Similarly, candidates with a fail score may be exited from the application process (step 320). In an embodiment of the invention, the candidate may not re-apply for a position for a specified period of time, such as six months. In another embodiment of the invention, the candidate is not restricted from re-applying to the company for any period of time and may continually re-apply using system 10. Candidate data that system 10 receives from the candidate is saved in candidate database 180.

At the scheduled appointment, system 10 may subject the candidate to one or more candidate instruments 102 for assessing the candidate (step 310). Candidate instruments 102 may include computerized tests, simulations, and/or interviews that may provide a candidate with information about the job and measure the candidate's cognitive abilities, analytical abilities, or specialized skills. For instance, candidate instruments 102 may comprise a computerized job preview, an on-line application, and computerized tests, simulations, or interviews that may be scored to assess a candidate's value as a potential employee, including vendor provided tests such as customer comfort select (CSS), Practical Office Arithmetic (POA), and/or Journal of Artificial Societies on Social Stimulation (JASS). System 10 may present candidate instrument(s) 102 based on a particular job for which the candidate is applying. System configuration data 160 may contain a table associating each available job to one or more candidate instruments 102. Data gathered from the candidate instruments 102 is saved in candidate database 180.

Scoring module 106 may assign a raw score to candidate 100 based on his performance on each candidate instrument 102. Scoring module 106 may then standardize the raw score. Decisioning module 107 may determine whether the standardized score is above or below a cutoff score. If the candidate's score is at or above the cutoff score, then module 107 will pass the candidate. If he scores below the cutoff, then module 107 fails the candidate.

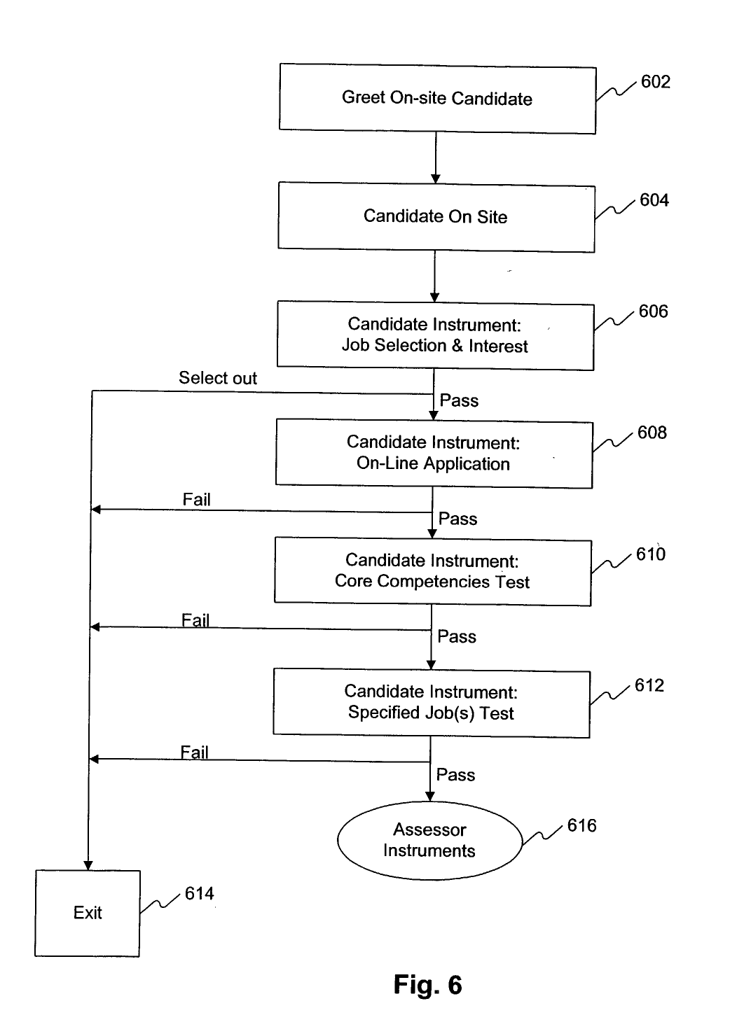

If decision module 107 determines that candidate 100 fails any candidate instrument 102, then decisioning module 107 may send a fail score to routing module 108, and routing module 108 may exit the candidate from the process (step 320). Similarly, if candidate 100 wishes to withdraw his application, routing module 108 may gracefully exit the candidate from the on-site processing (step 320). Alternatively, routing module 208 may temporarily exit the candidate from system 10 if the candidate needs to suspend or reschedule the workstation activities (step 320). Routing module 208 may allow a candidate who suspended processing to pick up where he left off during the workstation activities at a later date. FIG. 6, described below, illustrates some exemplary candidate instruments in greater detail.

If decisioning module 107 determines that candidate 100 passes the required candidate instrument(s) 102, then routing module 108 may route the candidate to an assessor instrument 104 (step 312). An assessor instrument 104 may include a test, simulation, and/or interview that involves a participant, such as a recruiter. In an embodiment of the present invention, the interactive modules may include a personal interview and a job simulation. System 10 may present assessor instrument 104 based on a particular job for which the candidate is applying. For example, a candidate applying for a call center position may receive an in-person interview over the telephone and a call center phone simulation. System configuration data 160 may contain a table associating each available job to one or more assessor instruments 104. Scoring module 106 may score candidate 100 for each interactive module and standardize the score. Decisioning module 107 may generate a pass/fail score based upon the standardized score, as described above. The pass/fail results may be recorded in candidate database 180.

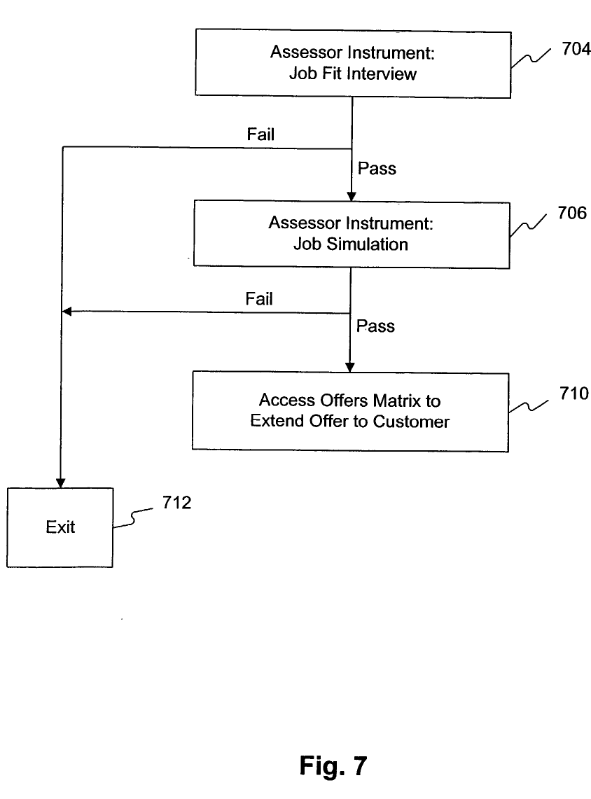

If decisioning module 107 determines that candidate 100 fails any of the required assessor instrument(s) 104, then routing module 108 may exit the candidate from the processing using system 10 (step 320). Similarly, candidate 100 may temporarily exit system 10 by suspending or rescheduling the interactive modules if needed (step 320). When the candidate returns on-site for further processing, he may pick up where he left off. FIG. 7, described below, illustrates an exemplary process for providing assessor instrument(s) and extending an offer to a candidate.

If decisioning module 107 determines that the candidate passes the required assessor instrument(s), then routing module 108 may route the candidate to offer module 110 (step 316). In one embodiment, if candidate 100 accepts the offer, an on-boarding process may be provided to later track the candidate's job performance in relation to his on-site processing scores (process not shown in FIG. 3). In this way, employment decisioning module 120 may be revised to optimize its prediction of a potential employee's success with the company based on the employees actual work performance with that company as monitored by the on-boarding process.

FIG. 4 is an exemplary flow diagram of a method, consistent with an embodiment of the present invention, for performing front-end processing of a candidate. Front-end processing may receive information from the candidate and process the information to determine whether the candidate meets predetermined criteria for further on-site candidate processing. Before gathering data regarding a candidate, system 10 may provide an overview of the company to which the candidate may apply for a position and the benefits provided. As shown in FIG. 4, candidate request module may provide information regarding open positions to the candidate (step 402). Such information may be provided to the candidate through the Internet or an interactive VRU using voice response technology. In response, a candidate may select and apply for one or more open positions, or the candidate may decide to review open positions at a later time if nothing of interest is presently found.

If the candidate applies for one or more open positions, system 10 may then present one or more required candidate instruments to the candidate based upon a job position selected by the candidate (step 404). Candidate instruments may include, for example, prescreen test, realistic job previews, bio data tests, applications with candidate approvals, cognitive and non-cognitive tests, computer simulations and/or credit checks.

For each required candidate instrument, a scoring module may accept raw scores from a completed candidate instrument and standardize the score (step 406). The scoring may be standardized using, for example, t-values corresponding to a t-distribution, a symmetrical, bell-shaped, theoretical probability distribution. A composite score also may be provided by applying a weighted average or Boolean logic to the scores. Weighting the scores allows the employer to assign the relative importance of each score or composite. The standardized score may then be sent to a decisioning module in real time. The decisioning module may determine a pass status for a completed candidate instrument when the standardized score is greater than a cutoff score, and a fail status otherwise (step 408).

As further illustrated in FIG. 4, an intake module may receive a pass or fail status of a candidate from the decisioning module (step 410). If intake receives a pass status, it forwards the candidate to a schedule module for scheduling a date and time for further processing on-site (step 412). Otherwise, if intake receives a fail status, it forwards the candidate to an exit module (step 414). The exit module may gracefully exit the candidate from the selection process. For example, it may thank the candidate for his time and advise him that his application will be kept on file for a predetermined time period, such as the next six months.

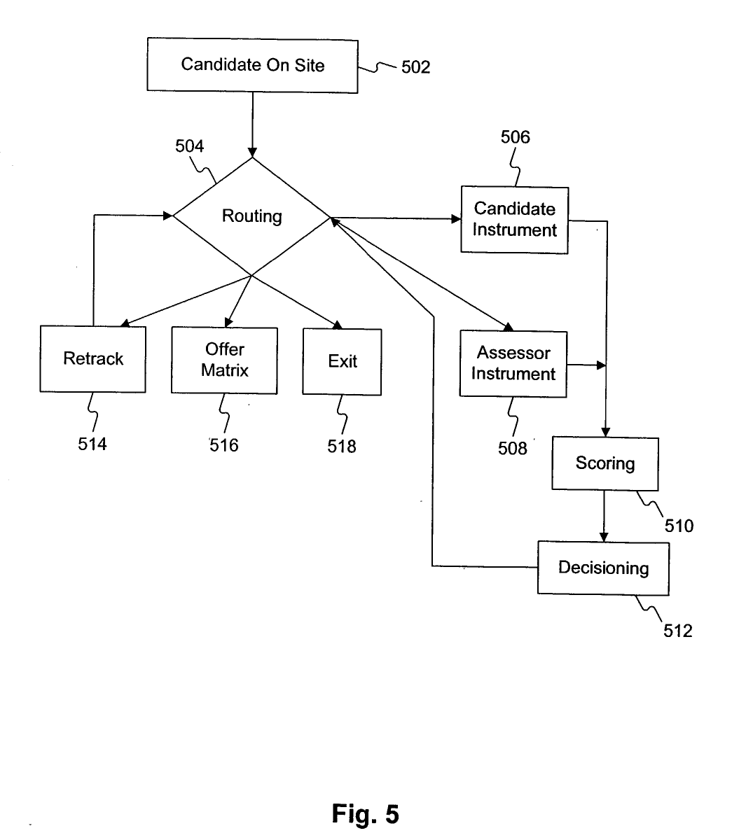

FIG. 5 is an exemplary flow diagram of a method, consistent with an embodiment of the present invention, for performing on-site processing of a candidate. A candidate scheduled for on-site processing may be logged into the on-site portion of the employment decisioning process by a candidate on-site module (step 502). In addition to logging on the candidate, candidate on-site module may initialize the system for candidate action and verify the status of the candidate.

A routing module, initialized by candidate on-site module, may direct the candidate through the on-site portion of the processing (step 504). As illustrated in FIG. 5, the routing module directs the candidate through the required candidate instrument (step 506) and the assessor instrument (step 508). Scoring module standardizes raw scores received from one or more candidate instruments and assessor instruments (step 510). Decisioning module determines a pass/fail status of the candidate based upon the standardized scores (step 512). The routing module continues to direct the candidates through the selection process until the candidate successfully completes all the required instruments and, thereafter, the candidate is routed to an offer matrix (step 516). If a candidate fails any instrument, he may be routed to a retrack module to receive processing for a different job position (step 514) or he may be routed to an exit module to be gracefully exited from system 10 (step 518).

FIG. 6 is an exemplary flow diagram of a method, consistent with an embodiment of the present invention, for implementing candidate instruments 102, described above with reference to the embodiment of FIG. 1 and the features of step 310 of FIG. 3. As disclosed herein, candidate instrument 102 may be implemented with system 10 of FIG. 1. Candidate instrument 102 may include, for example, a job preview, on-line application and/or computerized tools, such as tests and simulations. Once on-site, system 10 may greet a candidate, escort him to a testing room, and guide him through a candidate on-site module (steps 602 and 604). In one embodiment, candidate on-site module provides the candidate with a schedule for the on-site processing, initializes system 10 for candidate action, and logs the candidate into the on-site portion of the employment decisioning process. The candidate may log onto a workstation by entering his name and a unique identification number, such as a social security number. The log-on process may validate the candidate's identification against the database 180 to ensure the candidate exists and is active.

The candidate may be given a predetermined number of attempts to log onto the workstation. If the candidate cannot log into the workstation within the predetermined number of attempts, he may be referred to support staff to confirm his identity and scheduled appointment. The candidate on-site module may also initialize routing module 108 for processing.

After the candidate logs onto a workstation, a candidate instrument 102 may be implemented by system 10 to provide the candidate with, for example, video segments describing the company and selected jobs or job categories that are currently available (step 606). A job category describes a grouping of job positions. For example, a customer relations position and a collections position may fall into a customer service job category.

Although the candidate selected a particular job or job category of interest during the pre-screening process using system 10, the candidate may change this information after completing a candidate instrument in which the candidate previews, for example, video segments describing the various positions during processing using system 10. The video segments may provide a job description and job details, including a typical work schedule and salary information. For example, a video clip may show an employee of the company with the job being previewed describing the job environment and responsibilities. The candidate may view as many job previews as he desires, provided that he completes the previews within a designated time slot, such as thirty minutes. After watching the job previews or video clip, the candidate may select each job family or category that interests him the most, and may also select as may job positions that he would be willing to accept if extended a job offer. By providing the job preview, the candidate may better understand the job, and the candidate may use the information to pick his desired schedule and salary.

If the candidate cannot determine job category preferences or job positions, then routing module 108 may route the candidate to an exit before completing an on-line application (step 614). Otherwise, after selecting a position of interest, the candidate may decide on-line whether he can perform the essential job functions, as described, without accommodations, with accommodations, or not at all. If the candidate indicates that he cannot perform the essential job functions, even with accommodations, decisioning module 107 may fail the candidate for the candidate instrument 102 corresponding to the overview, and routing module 108 may receive the fail decision and exit the candidate.

If interested, the candidate may also apply for positions in one or more additional job categories. For example, the employee may apply for a job family of second choice. The candidate, as described above, may indicate the positions within the job family that he would be willing to accept if extended an offer, view the job requirements, and indicate whether he can perform the job requirements. The candidate is not required to choose a second job category preference.

Another candidate instrument provided to the candidate may include an on-line application implemented using system 10 (step 608). The on-line application may gather personal data from the candidate, such as name, street address, e-mail address (if applicable), telephone number, and minimum age of, for example, at least 18 years. The application may also gather, for example, referral information, non-English languages in which the candidate is fluent, previous employment information including salary, length of time with employer and reasons for leaving, education information, relatives employed by the company, desired scheduling and salary, job capability information (i.e., candidate's assessment of his ability to perform the essential functions with and without accommodations, as described above), bond application difficulty by former employer on candidate's behalf (i.e., difficulty in having an employer purchase coverage to protect it against theft of money, securities, or property by candidate), and/or criminal history.

The on-line application may query the candidate to determine whether the candidate satisfies prerequisites mandatory for employment with the company. For example, the on-line application may ask the candidate whether he is eligible to work in the United States of America and agrees to the company's employment conditions clause. A company may have other requirements depending upon the nature of its work. For example, a credit card company or other financial institution may require an employee to have good credit. Thus, a prerequisite for employment may be providing consent to the company to conduct a credit report. Similarly, a government agency may require a candidate provide consent to conduct a security check on the candidate. Additionally, the on-line application may query the candidate to determine whether he accepts the employment conditions of the position, such as its hours and salary. If the candidate answers no to any of these pre-determined requirements, decisioning module 107 may provide a fail decision to routing module 108, and routing module 108 may exit the candidate (step 614). Thus, the company may avoid the expense of determining the candidate's skills and competency tests.

Another candidate instrument provided to the candidate may include a credit check. Upon receiving consent from the candidate to conduct a credit check, the process may automatically obtain a credit report from a vendor or credit bureau. The candidate instrument may generate a raw score based on the report and forward the score to scoring module 106, or it may forward a credit score provided by the report to scoring module 106. Scoring module 106 may standardize the score, and decisioning module 107 may use the standardized score to generate a credit pass or fail score. Although a candidate with a failing credit score may not receive a job offer, the process may allow the candidate to proceed with the on-site processing. If the candidate passes each of the selection processes, decisioning module 107 may will provide a status to routing to give the candidate an opportunity to correct any errors on his credit report to obtain a job, for example.

If the candidate meets the preliminary employment criteria, then another candidate instrument 102 may be implemented by system 10 to test the candidate's core competencies (step 610). The core competency tests may include computer activities that may be scored by scoring module 106 to evaluate the candidate's cognitive and/or analytic skills. These tests may include commercialized available products. Alternatively a company may design its own test.

Scoring module 106 may score the candidate's performance on the core competency test, and decisioning module 107 determines a pass/fail status for the candidate based on the score received from scoring module 106. If decisioning module 107 determines that the candidate fails, it may pass a fail decision to routing module 108. Routing module 108 may exit the candidate from the on-site processing (step 614). Alternatively, routing module 108 may route the candidate to a competency test for another job position. If routing module 108 receives a pass decision, routing module 108 may route the candidate to job specific testing (step 612).

Job specific testing is another candidate instrument that may be implemented in system 10. Job specific testing may include a job simulation scored by module 106 to assess a candidate's job skills. For example, if the candidate is applying for a job at a call center, job specific testing may simulate customer service calls. The candidate may listen to the simulated customer calls and input answers into the workstation. The program may simulate a simulated customer's next response based upon a response selected by the candidate.

Scoring module 106 may score the candidate's performance on job specific testing and generate a pass or fail decision. If decisioning module 107 determines that the candidate fails or the candidate chooses to withdraw, routing module 108 may exit the candidate from the processing (step 614). Alternatively, routing module may retrack the customer to complete candidate instruments 102 associated with another job. If decisioning module 107 determines that the candidate passes, the candidate may proceed with the assessor instruments (step 616).

FIG. 7 is an exemplary flow diagram of a method, consistent with an embodiment of the present invention, for implementing step 616 of FIG. 6. Assessor instruments 104 may be implemented with system 10 of FIG. 1. Assessor instruments 104 may include, for example, a job fit interview (step 704) and job simulation (step 706).

During the job fit interview (step 704), the recruiting specialist may ask the candidate a series of questions, similar to a typical interview. However, the testing methodology may vary depending on the job position. For example, in recognition of the vast amount of telephone time a call center position requires, a candidate applying for a call center position may conduct the job fit interview over the telephone.

After the job fit interview, support staff, such as a recruiting specialist, may update monitoring module 112 with a pass or fail decision for the candidate. If decisioning module 107 determines from a score received from scoring module 106 that the candidate fails the job fit interview, it may send a fail decision to routing module 108 and routing module 108 may exit the candidate from the process used by system 10 (step 712). Alternatively, routing module 108 may retrack the candidate to determine whether the candidate's routing module qualifies for another job (not shown). For example, the candidate may be retracked to step 310 of FIG. 3 where the candidate may be subjected to candidate instruments 102 associated with an alternative job position.

However, if decisioning module 107 determines that the candidate passes the job fit interview, module 107 may send a pass decision to routing module 108 and module 108 may direct the candidate to a job simulation (step 706). For example, the job simulation for a candidate applying for a call center position may be a phone simulation. Particularly, the candidate may play the role of a representative in a customer service department, and the recruiter specialist may play the roles of five different callers. The phone simulation may allow the company to evaluate the candidate in a call center environment. In addition, the simulation may allow the candidate to better understand how a call center operates.

Other job simulations are possible. For example, a bi-lingual candidate also may apply for a job as a call center position. In this example, the bi-lingual candidate may be given a bi-lingual assessment after passing the phone simulation. If decisioning module 107 determines from a score received from scoring module 106 that the bi-lingual candidate passes, it may send a pass decision to routing module 108 and routing module 108 may direct the candidate to offer module 110. Offer module 110 may offer the candidate a bi-lingual job. Otherwise, routing module 108 may direct the candidate to offer module 108 with an English only position. Although a call center position job has been described, one skilled in the art can appreciate that the employment decisioning process described herein may be applied to any job.

If decisioning module 107 determines from a score received by scoring module 106 that the candidate fails, module 107 may send a fail decision to routing module 108 and routing module 108 may exit the candidate from the process used by system 10 or retrack the candidate for process used by system 10 for another job (step 712). However, if decisioning module 107 determines that the candidate passes the simulation, module 107 may send a pass decision to routing module 108 and routing module 108 may forward the candidate to offer module 110 may extend an offer to the candidate immediately that same day (step 710). Particularly, offer module 110 may provide the candidate with specifics of each job that he qualifies for, along with a specific salary for each job.

If the candidate objects to the indicated salary, support staff may explain monthly incentive potential and other performance based incentives. If the candidate still wishes to negotiate his salary and the salary he seeks is within a designated range for that position, support staff may review the candidate's application to determine if higher salary warranted. If a higher salary is warranted, support staff may extend an offer with a higher salary that day. Otherwise, support staff may advise of such and ask candidate how he wishes to proceed. Likewise, if a candidate requests a salary significantly above the salary range for the position, support staff may advise the candidate that his request cannot be granted and ask the candidate how he wishes to proceed.

Other embodiments of the invention will be apparent to those skilled in the art from consideration of the specification and practice of the invention disclosed herein. For example, one or components or steps in the disclosed systems and methods may be substituted, combined and/or replaced. In addition, the order of the steps in the exemplary methods can be changed or modified according to certain needs or requirements. Accordingly, it is intended that the specification and disclosed embodiments be considered as exemplary only, with a true scope and spirit of the invention being indicated by the appended claims in light of their full scope of equivalents.

What is claimed is:

1. A system for processing a job candidate applying for a job position, the system comprising:
a receiving unit that receives a request from a job candidate about whether a job position is available;
a decisioning unit that determines whether to approve the job candidate for the requested job position based on applicant information provided by the job candidate;
a scheduler that schedules the candidate for further application processing when the job candidate is approved for the requested job position; and
a database that stores the applicant information from the job candidate, the approval determination, and any scheduling information for any scheduled appointment for further application processing.

2. The system of claim 1, wherein the receiving unit receives the request over an Internet connection.

3. The system of claim 2, wherein the receiving unit includes a Web page for receiving the request from the job candidate.

4. The system of claim 1, wherein the receiving unit receives the request over a telephone network.

5. The system of claim 4, wherein the receiving unit includes a voice recognition unit (VRU) for receiving the request from the job candidate.

6. The system of claim 1, wherein the scheduler transfers the job candidate to an operator to schedule the appointment for further application processing.

7. The system of claim 1, wherein the decisioning unit determines whether to approve the candidate based on a prior work history of the candidate.

8. The system of claim 1, wherein the decisioning unit determines whether to approve the candidate based on whether the job candidate approves of at least one of a listed salary and schedule of the job position.

9. The system of claim 1, wherein the decisioning unit determines whether to approve the candidate based on whether the job candidate is applying before a predetermined period of time has elapsed since the job candidate previously applied for the job position.

10. The system of claim 1, wherein the receiving unit allows the job candidate to select a job position from job positions currently available, and wherein the receiving unit provides the job candidate with a description of the selected job position.

11. The system of claim 10, wherein the receiving unit further includes:
means for selecting the job position for the job candidate based on at least one of a desired job schedule and a desired salary provided by the job candidate.

12. A network based computer system for determining whether to hire a candidate, the system comprising:
a receiving unit that receives a request from a candidate to apply for a first job position;
an interface component that presents to the candidate a predetermined skills test that is selected based on the first job position requested by the candidate;
a scoring component for determining a candidate score based on responses made by the candidate to the predetermined skills test; and
a decisioning component for determining whether to accept the candidate for hiring based on the determined candidate score.

13. The system of claim 12, wherein the predetermined skills test includes at least one of a predetermined analytical test and a simulation of the requested job position.

14. The system of claim 12, wherein the simulation of the requested job includes simulating a call from a customer to a customer service representative, wherein the candidate simulates the customer service representative, and wherein the scoring component further includes:
means for scoring the candidates response to the simulated customer call.

15. The system of claim 12, wherein the decisioning component further includes means for determining, based on the candidate score, that the candidate satisfies predetermined hiring criteria for a second job position different than the first job position, and wherein the system further includes:
a routing component that retracks the candidate such that the interface component presents a predetermined skills test for the second job position when the candidate meets the predetermined hiring criteria for the second job position.

16. The system of claim 12, wherein the interface component provides a description of the first job position from a current employee working at the first job position.

17. The system of claim 12, wherein the interface component provides a description of at least one of the actual environment, benefits, salary, and responsibilities of the first job position.

18. The system of claim 12, wherein the interface component allows the candidate to select the first job position from job positions currently available, and provides the candidate with a description of the selected first job position.

19. The system of claim 18, wherein the interface component further includes:
means for selecting the first job position for the job candidate based on at least one of a desired job schedule and a desired salary provided by the candidate.

20. The system of claim 12, wherein the decisioning component further includes:
means for comparing the candidate score to a threshold value associated with the first job position; and
means for accepting the candidate when the candidate score satisfies the threshold value.

21. The system of claim 20, wherein the scoring component includes converting responses made by the candidate to a standardized score.

22. The system of claim 12, wherein the scoring component further includes:
means for determining an interview score component based on a personal interview of the candidate, and wherein the candidate score is based on the interview score component.

23. The system of claim 22, wherein the interview is conducted using the interface component, and wherein the interface component includes a computer terminal operated by the candidate.

24. The system of claim 22, wherein the interview is conducted telephonically.

25. The system of claim 12, further including:
means for determining a credit rating of the candidate to determine a credit score component, and wherein the candidate score is also based on the credit score component.

26. The system of claim 12, further including:
means for monitoring, when the candidate is hired, the candidate's job performance;
means for determining whether the determined candidate score for the candidate reflects the monitored job performance of the candidate; and
means for updating at least one of the predetermined skills test and the scoring component, based on the determination of whether the candidate score reflects the candidate's job performance.

27. The system of claim 12, wherein the system determines whether to hire the candidate within one business day.

28. The system of claim 12, further including:
an application component for allowing the candidate to complete an application for the requested job position; and
an application analysis component for analyzing the completed application to determine whether to approve the candidate for the requested job position; and
a routing module for exiting the candidate from the hiring process when the candidate is not approved for the requested job position.

29. The system of claim 12, further comprising:
a pre-screening component for determining whether the candidate qualifies for being provided with the predetermined skills test using the interface component; and
a scheduler that schedules the candidate for testing using the interface component when the candidate is determined to be qualified.

30. A method for processing a job candidate applying for a job position, the method comprising:
receiving a request from a job candidate about whether a job position is available;
determining whether to approve the job candidate for the requested job position based on applicant information provided by the job candidate;
scheduling the candidate for further application processing when the job candidate is approved for the requested job position; and
storing the applicant information from the job candidate, the approval determination, and any scheduling information for any scheduled appointment for further application processing.

31. The method of claim 30, wherein receiving includes receiving the request over an Internet connection.

32. The method of claim 31, wherein the request from the job candidate is received by a Web page.

33. The method of claim 30, wherein the request from the job candidate is received over a telephone network.

34. The method of claim 33, wherein receiving includes receiving the request from the job candidate via a voice recognition unit (VRU).

35. The method of claim 30, wherein scheduling includes transferring the job candidate to an operator to schedule the appointment for further application processing.

36. The method of claim 30, wherein determining includes determining whether to approve the candidate based on a prior work history of the candidate.

37. The method of claim 30, wherein determining includes determining whether to approve the candidate based on whether the job candidate approves of at least one of a listed salary and schedule of the job position.

38. The method of claim 30, wherein determining includes determining whether to approve the candidate based on whether the job candidate is applying before a predetermined period of time has elapsed since the job candidate previously applied for the job position.

39. The method of claim 30, wherein receiving further includes
allowing the job candidate to select a job position from job positions currently available; and
providing the job candidate with a description of the selected job position.

40. The method of claim 39, wherein receiving further includes:
selecting the job position for the job candidate based on at least one of a desired job schedule and a desired salary provided by the job candidate.

41. A method for determining whether to hire a candidate, the method comprising:
receiving a request from a candidate to apply for a first job position;
testing the candidate using a predetermined skills test that is selected based on the first job position requested by the candidate;
scoring a candidate with a candidate score based on responses made by the candidate to the predetermined skills test; and
deciding whether to accept the candidate for hiring based on the candidate score.

42. The method of claim 41, wherein the predetermined skills test includes at least one of a predetermined analytical test and a simulation of the requested job position.

43. The method of claim 42, wherein the simulation of the requested job includes simulating a call from a customer to a customer service representative, wherein the candidate simulates the customer service representative, and wherein scoring further includes:
scoring the candidates response to the simulated customer call.

44. The method of claim 41, wherein deciding further includes deciding, based on the candidate score, that the candidate satisfies predetermined hiring criteria for a second job position different than the first job position, and wherein the method further includes:
retracking the candidate to present a predetermined skills test for the second job position when the candidate meets the predetermined hiring criteria for the second job position.

45. The method of claim 41, wherein providing includes providing a description of the first job position from a current employee working at the first job position.

46. The method of claim 41, wherein providing includes providing a description of at least one of the actual environment, benefits, salary, and responsibilities of the first job position.

47. The method of claim 41, wherein providing further includes:
allowing the candidate to select the first job position from job positions currently available, and
providing the candidate with a description of the selected first job position.

48. The method of claim 47, further including:
providing a selection for the job candidate for the first job position based on at least one of a desired job schedule and a desired salary provided by the candidate.

49. The method of claim 41, wherein the deciding further includes:
comparing the candidate score to a threshold value associated with the first job position; and
accepting the candidate when the candidate score satisfies the threshold value.

50. The method of claim 41, wherein scoring further includes:
determining an interview score component based on a personal interview of the candidate, and wherein the candidate score is based on the interview score component.

51. The method of claim 50, wherein the interview is conducted using a computer terminal operated by the candidate.

52. The method of claim 50, wherein the interview is conducted telephonically.

53. The method of claim 41, further including:
determining a credit rating of the candidate to determine a credit score component, and wherein the candidate score is also based on the credit score component.

54. The method of claim 41, further including:
monitoring, when the candidate is hired, the candidate's job performance;
determining whether the determined candidate score for the candidate reflects the monitored job performance of the candidate; and
updating at least one of the predetermined skills test and the scoring component, based on the determination of whether the candidate score reflects the candidate's job performance.

55. The method of claim 41, wherein the system determines whether to hire the candidate within one business day.

56. The method of claim 41, further including:
allowing the candidate to complete an application for the requested job position; and
analyzing the completed application to determine whether to approve the candidate for the requested job position; and
exiting the candidate from the hiring process when the candidate is not approved for the requested job position.

57. The method of claim 41, further comprising:
determining whether the candidate qualifies for being provided with the predetermined skills test using the interface component; and
scheduling the candidate for testing when the candidate is determined to be qualified.

58. A method for determining whether to hire a candidate for a job, including:
identifying an automated selection process, the selection process being specific to the job; and
routing the candidate through the selection process, the selection process including
administering a selection instrument to the candidate;
receiving a response to the selection instrument from the candidate; and
determining whether to hire the candidate based upon the response.

59. The method of claim 58, wherein the selection process is specific to the candidate and the job.

60. The method of claim 58, wherein the selection process administers a plurality of selection instruments to the candidate and determines to hire the candidate when the candidate passes each instrument.

61. The method of claim 58, wherein the selection instrument includes at least one of a multiple-choice test, interactive computer simulation, interview, business case, and interactive simulation.

62. The method of claim 58, wherein the selection process further includes
scoring the response to obtain a standardized score; and
determining whether to hire the candidate when the score meets or exceeds a threshold.

63. A method for determining whether to hire a candidate for a job, including:
identifying a selection process, the selection process being specific to the job; and
routing the candidate through the selection process, the selection process including
administering a plurality of selection instruments to the candidate;
receiving a response from each selection instrument indicating a skill level of the candidate;
scoring each response to obtain a standardized score for each selection instrument; and
determining whether to hire the candidate based upon the standardized score.

64. The method of claim 63, wherein scoring includes converting the response from each selection instrument to a similar distribution.

65. The method of claim 63, wherein scoring includes combining responses to obtain at least one composite score.

66. The method of claim 65, wherein scoring further includes converting the composite score to a standardized value.

67. The method of claim 66, wherein scoring further includes combining more than one composite score to obtain a higher-order composite.

68. The method of claim 63, wherein scoring includes applying a weight to each response, indicating a relative importance for the response.

69. The method of claim 63, wherein scoring includes applying Boolean logic to each response to produce a Boolean composite score.
